(19) United States
(12) Patent Application Publication
(10) Pub. No.: US 2020/0116025 A1
(43) Pub. Date: Apr. 16, 2020

(54) TURBINE GUIDE APPARATUS WITH BLADED GUIDING DEVICE

(71) Applicant: MAN Energy Solutions SE, Augsburg (DE)

(72) Inventors: Christoph Leitenmeier, Augsburg (DE); Sebastian Spengler, Wehringen (DE)

(73) Assignee: MAN Energy Solutions SE

(21) Appl. No.: 16/567,774

(22) Filed: Sep. 11, 2019

(30) Foreign Application Priority Data
Oct. 11, 2018 (DE) 10 2018 125 148.3

(51) Int. Cl. F01D 5/14

(52) U.S. Cl. CPC F01D 5/141; F05D 2220/30

(57) ABSTRACT

A turbine guide apparatus for a turbine or a compressor with a rotor having a number of guide blades arranged on the rotor in the circumferential direction following one another at a non-equidistant, irregular interval Δ_{i,i+1}, wherein Δ_{i,i+1} each defines the interval of two guide blades directly following one another in the circumferential direction.

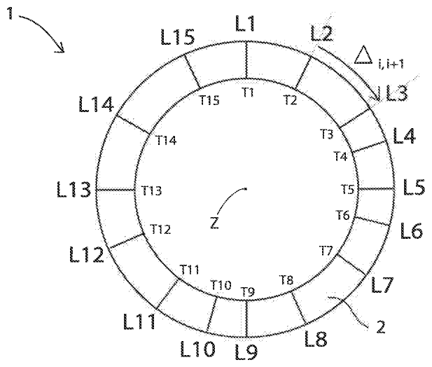

### BACKGROUND OF INVENTION

### 1. Field of the Invention

The invention relates to a compressor and to a turbine guide apparatus having a guiding device with guide blades.

### 2. Description of Related Art

A compressor is a machine (fluid energy machine) that supplies an enclosed gas with mechanical work. Compressors for this purpose are used for compressing gasses. In the process, they increase the pressure and the density of the working gas. Machines, in which a low compression is a side effect during the transport of gasses are called fans or blowers and are generally not considered to be compressors. A turbine is a rotating turbo machine that converts the dropping of the internal energy of a flowing fluid into mechanical power, namely torque times rotational speed, which speed it outputs again via its shaft.

A part of its internal energy is extracted from the fluid flow that is transferred to the moving blades of the turbine. The turbine shaft is then rotated by way of these blades; the utilisable power is used at an output. Because of the high mechanical and thermal stresses on account of the centrifugal force and the thermal gradients and transients during operation, the turbine rotors are considered a central point in designing a turbine. Besides an optimal configuration regarding efficiency, structure-mechanical aspects are therefore the center point of the configuration in order to ensure the operational safety of the turbine rotors. An important additional point here is realising a low turbine mass since the materials used are typically expensive and a low mass or a low mass moment of inertia is decisive for the acceleration behaviour. For an economical use of such turbines and compressors, the lifespan of the turbine rotors should be preferably improved and optimised. Limiting the lifespan of the turbines is material fatigue as a consequence of cyclical loads. Here, low-cyclical fatigue (LCF) and high-cyclical fatigue (HCF) overlap. Because of the high temperatures during operation, creep fatigue constitutes a further damage mechanism for the guide blades of the turbine wheel.

It is known that vibration-induced fractures of rotor blades of for example radial turbines, which are attributable to resonance oscillations, are among the most frequent causes of failures and damages in exhaust gas turbochargers of large diesel engines.

With a theoretically assumed ideal wheel geometry, in the case of which all guide blades are identically shaped, the nodal lines of the oscillations initially do not have a preferred position regarding the wheel. However, the guide blades behave like coupled oscillators relative to one another, which are distributed over the circumference of the rotor. Coupling the rotor blades is provided via the connection to the hub. In the case of a suitable oscillation excitation, a wave-like propagation of the blade oscillations in the circumferential direction can occur. The extent of this effect is dependent on the actual coupling between the blades.

### SUMMARY OF THE INVENTION

One aspect of the invention is therefore based on avoiding the aforementioned disadvantages and provide a solution with which in particular HFC damage of the rotor blades is significantly reduced or avoided.

One aspect of the present invention is that the guide blades are not each arranged in the circumferential direction in a sequence of equidistant intervals as is known from the prior art but at an irregular interval, thus at an interval pattern in which the interval of directly adjacent guide blades differs. Here, the interval in the circumferential direction can increase or decrease in each case from one guide blade to the next guide blade or if appropriate, also remain the same in order to increase or decrease again thereafter.

According to one aspect of the invention, a turbine guide apparatus for a turbine or a compressor guide apparatus for a compressor is designed for this purpose with a rotor having a number n of guide blades, which are arranged on the rotor in the circumferential direction in succession at a non-equidistant, irregular interval Δ_{i,i+1}, wherein Δ_{i,i+1} in each case defines the interval of two guide blades directly following one another in the circumferential direction (namely of the guide blade in the position i and the following guide blade in the position i+1). For this purpose, that interval in the circumferential direction along a fixed interval (radius) based on the center of the rotor is preferably taken into consideration.

In a preferred configuration of one aspect of the invention, it is provided that the n guide blades arranged distributed over the circumference are designed identical in their shape. In an alternative configuration it can also be provided, however, that individual or all of the guide blades in their shape are designed differently at least in a part region. Accordingly, for further excitation of subsidiary orders and for preventing main modes of a harmonic excitation, a shape change of individual guide blades can for example also contribute to this result.

It is additionally provided with advantage that a plurality of the intervals Δ_{i,i+1} of in each case two guide blades directly following one another in the circumferential directions is distinct. Accordingly, all guide blades can also be arranged for example on the rotor with a different interval in each case based on the directly adjacent guide blade. According to the invention it is provided for this purpose that all intervals Δ_{i,i+1} of in each case two guide blades directly following one another in the circumferential direction are distinct, as a result of which a division pattern in the circumferential direction with n of different angular division dimensions (based on 360°) is obtained.

In a further advantageous configuration of the invention it can be provided that the change of the interval Δ_{i,i+1} of in each case two guide blades to the respective following or preceding interval, varies. In particular it can be provided here that the change of the interval Δ_{i,i+1} of in each case two guide blades relative to one another to the interval Δ_{i-1,i} of the respective preceding guide blade or the interval Δ_{i+1,i+2} to the respective following guide blade is increasing or decreasing. By way of this, the interval of each two consecutive guide blades over the entire circumference differs from one another, as a result of which a division pattern in the circumferential direction with n different angular division dimensions (based on 360°) is obtained, such as for example an exemplary angular interval of in succession 20°, 30°, 27°, 18°, . . . , 33°.

It is advantageous, furthermore, when the respective interval Δ_{i,i+1} of each two guide blades in the circumferential direction is determined according to a predetermined division plan so that during an oscillation excitation during the operation of the turbine guide apparatus a targeted division of the periodic harmonic oscillation excitation into its subsidiary orders takes place.

A further aspect of the present invention relates to a turbine having a turbine guide apparatus as described above.

### BRIEF DESCRIPTION OF THE DRAWINGS

Other advantageous further developments of the invention are characterized in the subclaims or are shown in more detail by way of the FIGURES together with the description of the preferred embodiment of the invention. There it shows:

The FIGURE is an exemplary schematic embodiment of a turbine guide apparatus according to one aspect of the invention.

### DETAILED DESCRIPTION OF THE PRESENTLY PREFERRED EMBODIMENTS

In the following, the invention is explained in more detail making reference to the FIGURE, wherein in the FIGURE a merely exemplary plan view of a turbine guide apparatus 1 with the division positions T1 to T15 is shown, which represent the mounting positions of the guide blades L1, L2, . . . , L15.

The turbine guide apparatus 1 is designed for a turbine or a compressor and comprises a rotor 2 with a hub that is not shown in more detail in the center Z of the rotor 2. The 15 guide blades L1, L2, . . . , Li, Li+1, . . . L15, are consecutively arranged on the rotor 2 in the circumferential direction at a non-equidistant, irregular interval Δ_{i,i+1}.

Here, Δ_{i,i+1} each defines the relative interval in the circumferential direction along an arc of a circle line of two guide blades Li, Li+1 directly following one another in the circumferential direction.

As is further evident in the FIGURE, all intervals Δ_{i,i+1} of each two guide blades Li, Li+1 immediately following one another in the circumferential direction are distinct, as a result of which a division pattern in the circumferential direction with different angular division dimensions is obtained. Nevertheless, certain guide blade intervals can also occur multiple times, preferentially however always with at least one different guide blade interval of two guide blades located in between. Accordingly, the interval between the position of the guide blade L3 and the position of the guide blade L4 can be equal to the interval between the position of the guide blade L9 and the position of the guide blade L10.

In its embodiment, the invention is not limited to the preferred exemplary embodiments stated above. In this regard, the turbine guide apparatus is suitable both for a turbine or, embodied as compressor guide apparatus, for a compressor. On the contrary, a number of versions is conceivable which make use of the shown solution even with embodiments of a fundamentally different type.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A turbine guide apparatus for a turbine or a compressor comprising:
a rotor; and
a number n of guide blades arranged on the rotor following one another in a circumferential direction at a non-equidistant, irregular interval Δ_{i, i+1},
wherein Δ_{i, i+1} in each case defines the irregular interval of two guide blades directly following one another in the circumferential direction.

2. The turbine guide apparatus according to claim 1, wherein the n guide blades are identically designed in their shape.

3. The turbine guide apparatus according to claim 1, wherein the n guide blades are designed distinct in their shape at least in a part region.

4. The turbine guide apparatus according to claim 1, wherein a plurality of the irregular intervals Δ_{i, i+1} of two respective guide blades directly following one another in the circumferential direction is distinct.

5. The turbine guide apparatus according to claim 1, wherein all irregular intervals Δ_{i,i+1} of in each case two guide blades directly following one another in the circumferential direction are distinct, as a result of which a division pattern in the circumferential direction with different angular division dimensions is obtained.

6. The turbine guide apparatus according to any claim 1, wherein a change of the irregular interval Δ_{i,i+1} of in each case two guide blades to a respective following or preceding interval is unsteady.

7. The turbine guide apparatus according to claim 6, wherein the change of the irregular interval Δ_{i,i+1} of in each case two guide blades relative to one another to the irregular interval Δ_{i-1,i} of the respective preceding guide blade or the irregular interval Δ_{i+1,i+2} to the respective following guide blade is increasing or decreasing.

8. The turbine guide apparatus according to claim 1, wherein a respective irregular interval Δ_{i, i+1} of a respective two guide blades in the circumferential direction is determined according to a predetermined division plan so that upon an oscillation excitation during an operation of the turbine guide apparatus a targeted division of a periodically harmonic oscillation excitation into its subsidiary orders occurs.

9. A turbine comprising:
a turbine guide apparatus comprising:
a rotor; and
a number n of guide blades arranged on the rotor following one another in the circumferential direction at a non-equidistant, irregular interval Δ_{i, i+1},
wherein Δ_{i,i+1} in each case defines the irregular interval of two guide blades directly following one another in the circumferential direction.
